(19) United States
(12) Patent Application Publication
(10) Pub. No.: US 2005/0056975 A1
(43) Pub. Date: Mar. 17, 2005

(54) Method of preparing a crystal source mineral light wave magnetic energy anti-bacteria health product

(76) Inventor: Min-Fon Fan, Taipei City (TW)

Correspondence Address: Min-Fon Fan, PO Box 82-144, Taipei, TW

(21) Appl. No.: 10/656,149

(22) Filed: Sep. 8, 2003

(51) Int. Cl. C04B 33/32

(52) U.S. Cl. 264/611; 264/428

(57) ABSTRACT

A method of preparation of a crystal source light wave energy anti-bacteria health product is disclosed. Raw material of a specific ratio CaO, SiO₂, FeB, TiO₂ are crushed, colored, dried, and sintered to form permanent magnetic energy for making of pendant, bracelet, shoes soles or waist belt. These products improve blood circulation to enhance immune system and bacteria inhibition.

### BACKGROUND OF THE INVENTION

(a) Technical Field of the Invention

The present invention relates to a method of preparing a crystal source, mineral light magnetic energy anti-bacteria health product. The health product improves blood circulation, bacteria-killing and gem-inhibition.

(b) Description of the Prior Art

All living creatures have specific kinetic energy and the energy is related to the material of the universal and energy cannot be seen with human eyes. Energy is ultra micro particles and if it is mixed with external kinetic energy from other materials, resonance will be formed and it is naturally another form of kinetic energy.

Human body acts like a universe and such energy will affect the normal functioning of the human body. The energy that the human body receives can be experimented using O-ring test or other high technology devices (NUR) with respect to negative reaction of the energy. In view of the above, the inventor makes use of energy to form a health product, which improves immune of a human body.

U.S. Ser. No. 09/986,829 entitled “Light Wave Energy Health Magnetic Ring “discloses different types of magnetic ring to improve blood circulation. This patent discloses various types of arrangement of superconductor materials to form magnetic ring of different configuration. The ring will improve blood circulation of the human body. The applicant of the present application further carries out research so as to enhance the effectiveness of the previous patent.

### SUMMARY OF THE INVENTION

Accordingly, it is an object of the present invention to provide method of preparing a crystal source light wave energy anti-bacteria health product comprising the steps of: (a) crushing and screening raw materials; (b) coloring the crushed materials to produce a monochromatic colored materials; (c) forming the materials into a crystal size of 10 nm and particle size of 25 nm;(d) mixing the colored particles obtained in step (c);(e) forming and drying the particles obtained in step (d); (f) sintering the product of (e) at a high temperature between 1200 degree C. to 1350 degree C. for 9 to 13 hours; (g) dipping the product obtained in step (f) in nano size TiO2 and silver; (h) sintering product obtained at step (g) at 450 degree C.; (i) spraying a layer of light catalyst and dodecyl dietheny trihydroacetate and then drying to form a protective film; and (j) treating with high tension voltage to form permanent magnetic energy.

Still another object of the present invention is to provide a method of preparing a crystal source light wave energy gem-killing health product, wherein the crystal source light wave magnetic energy is made into pendant, bracelet, belt or made into kitchen wares tea sets or containers which are fabricated to generate natural strong magnetism, light wave energy, heat energy, or electrical energy to activate cells of the human body.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a block diagram showing the combination of the raw materials in accordance with the present invention.

FIG. 2 is a flowchart of the preparation method in accordance with the present invention.

FIGS. 3 and 4 are products obtained in accordance with the preferred embodiment of the present invention.

### DETAILED DESCRIPTION OF THE PRESNT INVENTION

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

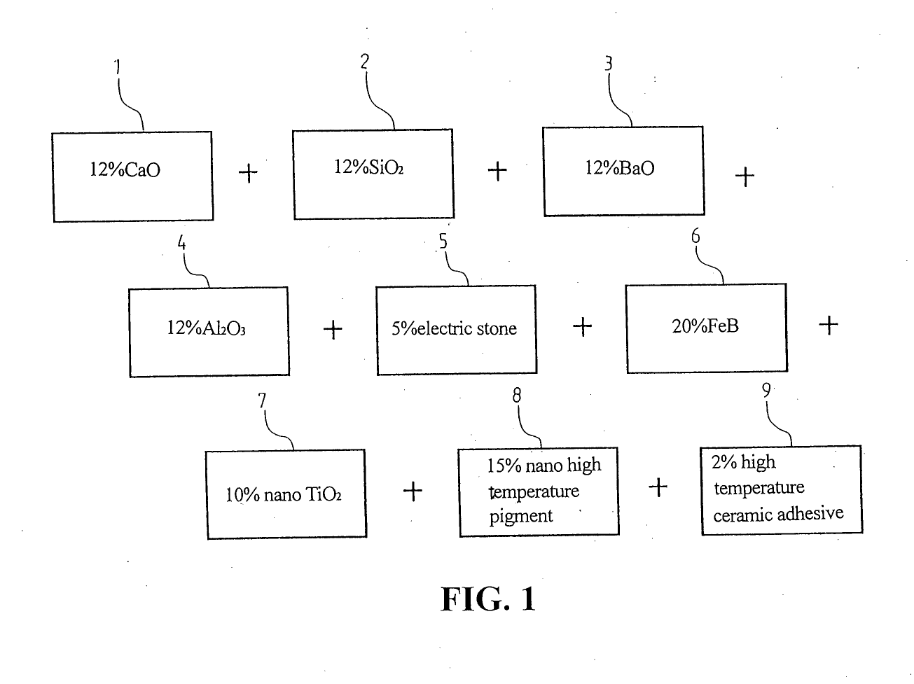

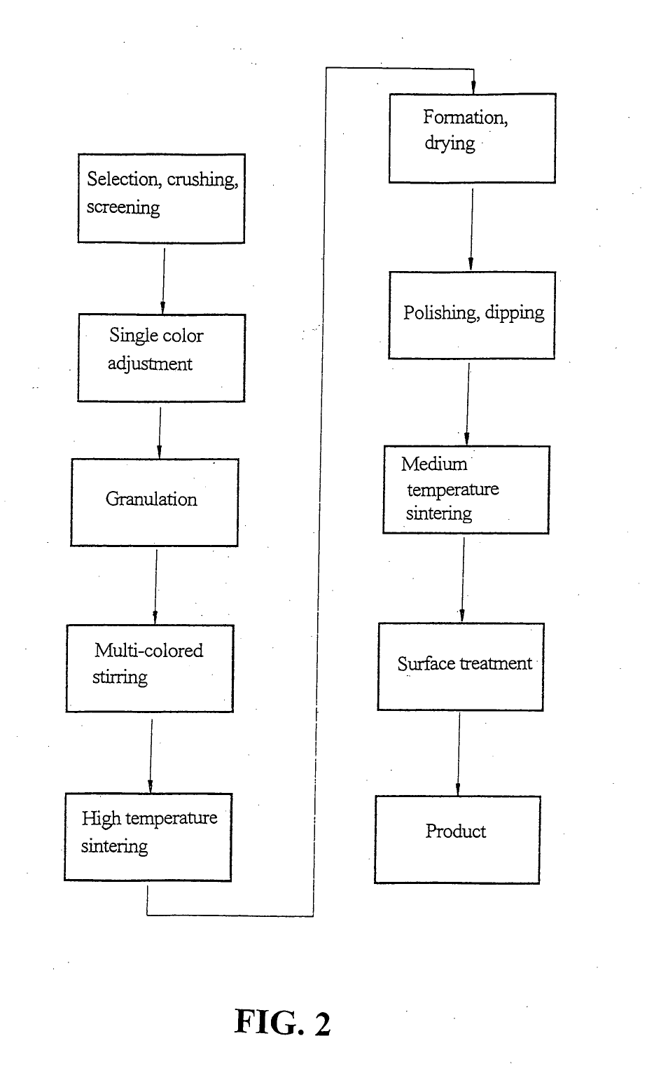

Referring to FIGS. 1 and 2, the raw materials in accordance with the present invention include CaO₂ (1): about 12%; SiO₂ (2): about 12%; BaO (3): about 12%; A1₂O₃ (4): about 12%; electric stone (5): about 5%; FeB (6): about 20%; TiO₂ (7): about 10%; high temperature resistance pigment (8): about 15%; and high temperature ceramic adhesive (9): about 2%.

After the components mentioned above are mixed, these mixed raw materials are undergone the following steps of preparation:
(a) selecting, crushing, screening the materials, such as CaO, SiO₂, BaO, Ah₂O₃, and electric stone are selected as these materials provide the best radiation rate of 8 to 12 μm, and the average is 9.5 μm;
(b) coloring the mixed materials with a single coloration;
(c) forming crystal of size 10 nm and particles of 25 nm;
(d) multiple coloring the particles and mixing the particles;
(e) forming and drying the product obtained in step (d);
(f) cooling and polishing the product of (e), dipping the product in TiO₂ and silver until the solution is fully penetrated;
(g) sintering the product of (f) at the temperature of 450 degree C.;
(h) spraying on the surface with light catalyst and dodecyldiethene trihydroacetate and drying to form a protective layer; and
(i) treating with high voltage current to form permanent magnetic energy for making of product.

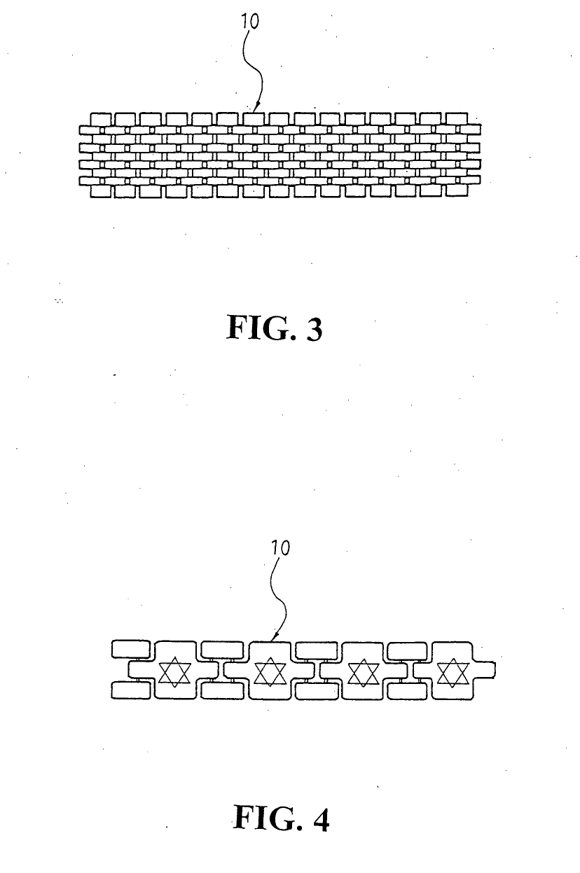

Referring to FIG. 3, the products that can be made from the present invention are bracelet 10, which can be arranged in “five row”, and “seven star”, etc., and can also be arranged, as shown in FIG. 4, hexagonal pattern to form health rings. It can also be made into chains or belt for the wearing onto the human body so as to improve blood and “chi” circulation and to achieve the objective of gem killing, or gem-inhibition.

In accordance with the present invention, the product obtained can be made into mattress, shoes pads, pillows or kitchen wares, tea sets, and other plasters which can be adhered onto the sculpture points and by means of the resonance of the magnetic energy, light wave energy and thermal energy, and electrical energy, the cells of the human body can be activated and the immune system is improved.

In accordance with a preferred embodiment of the present invention, the colored particles are mixed again such that the products have consistent color through out and provide an aesthetic appearance. The products not only provide health to the wearer but also act as an ornamental article. While the invention has been described with reference to preferred embodiments, it will be understood by those skilled in the art that various changes may be made and equivalents may be substituted for element thereof without departing form the scope of the invention. In addition, many modifications may be made to adapt a particular situation or material to the teachings of the invention without departing from the essential scope thereof. Therefore, it is intended that the invention may be limited to the particular embodiments disclosed as the best mode contemplated for carrying out this invention, but that the invention will include all embodiments falling within the scope of the appended claims.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. A method of preparing a crystal source light wave energy anti-bacteria health product comprising the steps of:
(a) crushing and screening raw materials;
(b) coloring the crushed materials to produce a monochromatic colored materials;
(c) forming the materials into a crystal size of 10 nm and particle size of 25 nm;
(f) mixing the colored particles obtained in step (c);
(g) forming and drying the particles obtained in step (d);
(h) sintering the product of (e) at a high temperature between 1200 degree C. to 1350 degree C. for 9 to 13 hours;
(i) dipping the product obtained in step (f) in nano size TiO2 and silver;
(j) sintering product obtained at step (g) at 450 degree C.;
(k) spraying a layer of light catalyst and dodecyl dietheny trihydroacetate and then drying to form a protective film; and
(l) treating with high-tension voltage to form permanent magnetic energy.

2. The method of claim 1, wherein the raw material includes 12% CaO, 12% SiO₂, 12% BaO₂, 12% Al₂O₃, 5% electric stone, 20% FeB, 10% TiO₂, 15% high temperature pigment and 2% high temperature ceramic adhesive.

3. The method of claim 3, wherein the extraction radiation rate of the raw material of CaO, SiO₂, BaO, Al₂O₃ and electric stone is 8 to 12 um and the average radiation rate is 9.5 um.
